(19) United States
(12) Patent Application Publication
(10) Pub. No.: US 2026/0259151 A1
(43) Pub. Date: Sep. 3, 2026

(54) INSPECTION DEVICE

(71) Applicants: MITSUBISHI HEAVY INDUSTRIES, LTD., Tokyo (JP); RIKEN, Wako-shi, Saitama (JP)

(72) Inventors: Keisuke KAJIKAWA, Tokyo (JP); Jun YASUI, Tokyo (JP); Soki AKUTSU, Tokyo (JP); Hiroaki MINAMIDE, Wako-shi (JP)

(73) Assignees: MITSUBISHI HEAVY INDUSTRIES, LTD., Tokyo (JP); RIKEN, Wako-shi, Saitama (JP)

(21) Appl. No.: 19/491,235

(22) PCT Filed: Jul. 9, 2024
(86) PCT No.: PCT/JP2024/024696

§ 371 Date: Dec. 8, 2025

(30) Foreign Application Priority Data
Aug. 30, 2023 (JP) 2023-139490

(51) Int. Cl. G01N 21/954; G01B 11/02; G01N 21/3581

(52) U.S. Cl. CPC G01N 21/954; G01B 11/026; G01N 21/3581; G01N 2021/9548

(57) ABSTRACT

An inspection device is a device for inspecting an inner peripheral surface of an inspection target having a cylindrical shape. The device includes: an inspection part for emitting a terahertz wave to the inner peripheral surface and detecting a reflection wave of the terahertz wave; and a distance measurement part for measuring a distance between the inspection part and the inner peripheral surface. The inspection part and the distance measurement part are rotated along a circumferential direction of the inspection target. The axial-directional position of the inspection part relative to the inspection target is adjusted. The position of the inspection part on a plane which intersects with an axial direction of the inspection target is adjustable. The position adjustment mechanism is controlled such that a rotational center of the rotation part is positioned on a center axis of the inspection target on the basis of a measurement result of the distance measurement part.

### TECHNICAL FIELD

The present disclosure relates to an inspection device.

The present application claims priority based on Japanese Patent Application No. 2023-139490 filed on Aug. 30, 2023 with the Japanese Patent Office, the contents of which are incorporated herein by reference.

### BACKGROUND ART

Patent Document 1 discloses a terahertz wave measurement device (inspection device) of a reflection type configured to be capable of emitting a terahertz wave being a type of electromagnetic waves, on a surface of a structure, and detecting a terahertz wave reflected on a structure. Such a terahertz wave measurement device includes a terahertz wave emitting device as a terahertz wave emitting means and a terahertz wave detection device as a terahertz wave detection means. In such a terahertz wave measurement device, a terahertz wave emitting device uses a terahertz wave generation element including a resonant-tunneling diode (RTD) or a photoconductive antenna (PCA), and a terahertz wave emitting device uses a terahertz wave detection element including RTD.

### CITATION LIST

### Patent Literature

Patent Document 1: JP2020-26991A

### SUMMARY

### Problems to Be Solved

An inspection device using the above described terahertz wave inspects, for instance, a pipe member having a cylindrical shape as an inspection target. In this case, the inspection device is positioned on the center axis in the internal space of the inspection target, and is capable of inspecting the inner peripheral surface of the inspection target over a wide range by performing an inspection work of detecting reflection waves while emitting terahertz waves to the internal space of the inspection target along the circumferential direction repetitively while moving in the axial direction. In the inspection, while the signal strength of the reflection waves from the inner surface is substantially constant in an area where the inner surface is normal, the signal strength of the reflection waves decreases in an area where there is abnormality on the inner surface (corrosion or presence of water, for instance). Thus, by plotting the distribution of the signal strength, it is possible to image the state of the inner surface.

Herein, a terahertz wave is an electromagnetic wave which has a high frequency, and thus has a high directionality and an excellent straightness. Thus, if the emission position of terahertz waves is offset from the center axis, it is difficult to obtain substantially constant signal strength upon emission of the terahertz wave to the inner surface along the circumferential direction, even in a case where the inner surface is in a normal state, which makes it difficult to accurately determine abnormality (such as corrosion and water) on the basis of the signal strength.

At least one embodiment of the present disclosure was made in view of the above, and an object is to provide an inspection device capable of inspecting the state of the inner surface of an inspection target having a cylindrical shape at a high accuracy by emitting a terahertz wave to the inner surface of the inspection target along the circumferential direction from a position on the center axis of the inspection target.

### Solution to the Problems

To solve the above problem, according to at least one embodiment of the present disclosure, an inspection device for inspecting an inner peripheral surface of an inspection target having a cylindrical shape includes: an inspection part for emitting a terahertz wave to the inner peripheral surface and detecting a reflection wave of the terahertz wave; a distance measurement part for measuring a distance between the inspection part and the inner peripheral surface; a rotation part for rotating the inspection part and the distance measurement part along a circumferential direction of the inspection target; a position adjustment mechanism for adjusting a position of the inspection part on a plane which intersects with an axial direction of the inspection target; and an axial-direction position adjustment part for adjusting an axial-direction position of the inspection part relative to the inspection target. The position adjustment mechanism is configured to be controlled such that a rotational center of the rotation part is positioned on a center axis of the inspection target on the basis of a measurement result of the distance measurement part.

### Advantageous Effects

According to at least one embodiment of the present disclosure, it is possible to provide an inspection device capable of detecting the state of the inner surface of an inspection target having a cylindrical shape at a high accuracy by emitting a terahertz wave to the inner surface of the inspection target along the circumferential direction from a position on the center axis of the inspection target.

### BRIEF DESCRIPTION OF DRAWINGS

FIG. 1 is a schematic external view of an inspection device according to an embodiment.

FIG. 2 is a block configuration diagram of the control device in FIG. 1.

FIG. 3 is a flowchart of an inspection method according to an embodiment.

FIG. 4 is an example of an inspection result obtained in step S107 of FIG. 3.

FIG. 5 is a flowchart of an inspection method according to another embodiment.

FIG. 6 is an example of correction data prepared in step S200 of FIG. 5.

FIG. 7 is a flowchart of an inspection method according to another embodiment.

### DETAILED DESCRIPTION

An inspection device according to an embodiment will now be described in detail with reference to the accompanying drawings. It is intended, however, that unless particularly identified, dimensions, materials, shapes, relative positions and the like of components described in the embodiments shall be interpreted as illustrative only and not intended to limit the scope of the present invention.

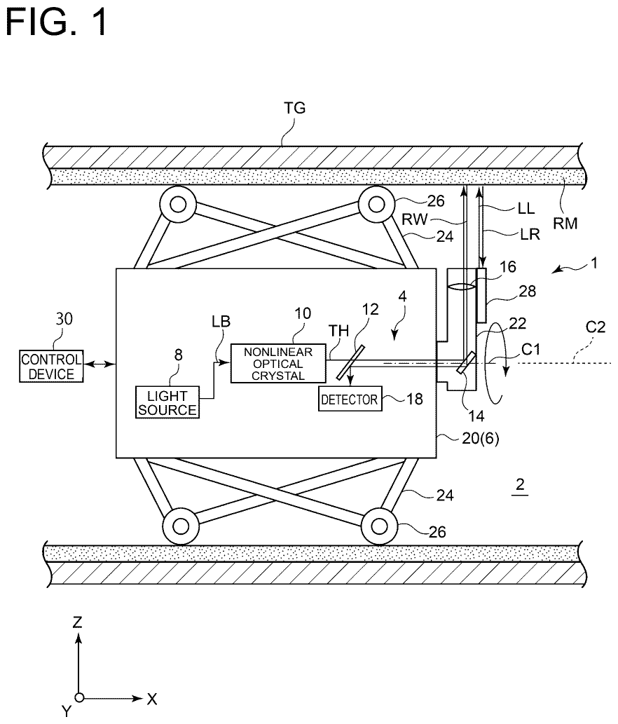

The configuration of an inspection device 1 according to at least one embodiment of the present disclosure will be described with reference to FIG. 1. FIG. 1 is a schematic external view of an inspection device 1 according to an embodiment.

The inspection device 1 is a device for inspecting an inspection target TG. The inspection target TG is a pipe member including a metal material having a substantially cylindrical shape, such as an iron pipe. The inspection target TG has an internal space 2 extending in the axial direction X. The inner peripheral surface of the internal space 2 has a substantially constant curvature on a YZ plane vertical to the axial direction X. The inner peripheral surface is lined with a resin material RM. If the resin material RM deteriorates, impregnation of water may cause corrosion on the inner wall of the iron pipe. An object of the inspection device 1 is to detect existence of corrosion on the inner peripheral surface of the inspection target TG, or water that causes corrosion as an abnormality.

The inspection device 1 includes a body 6 housing an optical system 4 as an inspection part for performing inspection. The optical system 4 includes a light source 8, a nonlinear optical crystal 10, a half mirror 12, a mirror 14, a condenser lens 16, and a detector 18.

The light source 8 is a component for outputting a pulse excitation light LB. The pulse excitation light LB is, for instance, outputted at a pulse duration of not longer than one microsecond, or preferably, not longer than one nanosecond. In the present embodiment, the light source 8 outputs pulse excitation light LB at a duration between ten picoseconds and ten nanoseconds. The light source 8 includes, for instance, a beam light source such as a tip laser.

The light source 8 is not limited to a component disposed inside the body 6 as depicted in FIG. 1, and may be disposed outside the body 6. In this case, the light source 8 may be configured such that pulse excitation light from the light source 8 is transmitted to the inside of the body 6 from the light source 8 positioned outside the body 6 through an optical fiber or the like.

The nonlinear optical crystal 10 is a feature for generating a terahertz wave TH by optical wavelength conversion of the pulse excitation light LB. The nonlinear optical crystal 10 is, for instance, a crystal of periodically poled lithium niobate (LiNbO₃), and a periodically poled lithium niobate crystal generates a terahertz wave TH through backward terahertz wave TH oscillation. The terahertz wave TH is an electromagnetic wave whose frequency is near 10¹² Hz (1 trillion hertz) (0.1 to 100 THz).

The terahertz wave TH generated by the nonlinear optical crystal 10 passes through the half mirror 12, is deviated by the mirror 14, and is emitted to the inner peripheral surface of the inspection target TG via the condenser lens 16. The reflection wave RW from the inspection target TG is condensed by the condenser lens 16, deviated by the mirror 14, passes through the half mirror 12 and is detected by the detector 18. As described above, in the optical system 4, when the inspection target TG is inspected, the terahertz wave TH is condensed by the condenser lens 16 and emitted to the inspection target TG. Thus, the terahertz wave TH is collected at the inspection target TG, and it is possible to detect a reflection wave RW having a high resolution with the detector 18.

As described above, in the optical system 4, the terahertz wave TH is generated by optical wavelength conversion as the pulse excitation light LB having a duration from ten picoseconds to ten nanoseconds penetrates through the nonlinear optical crystal 10, and thus the terahertz wave TH is stronger (has a higher output) than terahertz waves emitted from a semiconductor element such as RTC and PCA. Thus, it is possible to dispose the optical parts constituting the optical system 4 (the light source 8, the nonlinear optical crystal 10, and the like) at positions remote and separate from the inspection target TG. Furthermore, even in a case where the resin material RM disposed on the inner peripheral surface of the inspection target TG is a material that has a low permeability, the terahertz wave TH penetrates through the resin material RM and is reflected at the inspection target TG. Thus, even in a case where the inspection target TG is covered with the resin material RM including a low-permeability material, it is possible to inspect the inspection target TG.

Furthermore, while it is necessary to increase the output of the light source 8 to ensure an appropriate signal-to-noise ratio in imaging of a low-permeability material, oscillation of continuous waves such as that of a gyrotron oscillator requires a great amount of power and may lead to heat damage of the target. Meanwhile, the light source 8 uses the terahertz wave TH of pulse oscillation, and thus requires less power while ensuring a high peak power. Thus, it is possible to realize non-destructive imaging with a high permeability performance without damaging the inspection target TG with heat.

The body 6 housing the optical system 4 having the above configuration includes a housing 20, and an arm mechanism 22 attached rotatably with respect to the housing 20.

The housing 20 includes the light source 8, the nonlinear optical crystal 10, the half mirror 12, and the detection part 18 of the optical system 4. The light source 8 and the nonlinear optical crystal 10 are positioned such that the terahertz wave TH output from the nonlinear optical crystal 10 passes through the rotational center C1 of the arm mechanism 22.

Furthermore, a multiaxial arm 24 is disposed on the outer circumference of the housing 20. The arms of the multiaxial arm 24 are disposed at regular intervals in the circumferential direction of the housing 20, and configured to extend outward in the radial direction of the housing 20. Each of the arms is telescopic, thereby constituting a YZ-direction position adjustment mechanism for adjusting the position of the inspection device 1 on the YZ plane (plane perpendicular to the axial direction X). Each arm of the multiaxial arm 24 has a pantograph shape, and a traveling wheel 26 is disposed at the joint portion of the arm, so that the arm is movable along the axial direction X inside the inspection target TG while supporting the housing 20 on the inner peripheral surface of the inspection target TG.

While the multiaxial arm 24 is illustrated in the present embodiment as an example of the YZ-direction position adjustment mechanism, the configuration of the YZ-direction position adjustment mechanism is not particularly limited.

The arm mechanism 22 is a rotary part capable of rotating about the optical system 4 being an inspection part and the distance measurement part 28 along the circumferential direction. The arm mechanism 22 is mounted to the housing 20 rotatably about the rotational center C1 along the axial direction X, and houses the mirror 14 and the condenser lens 16 of the optical system 4. The arm mechanism 22 includes a first end side on which the mirror 14 is disposed and a second end on which the condenser lens 16 is disposed. The first end side is attached rotatably to the housing 20. In particular, the mirror 14 is disposed on the rotational center C1 of the arm mechanism 22, and thereby disposed at a position where the mirror 14 is capable of receiving the terahertz wave TH output from the nonlinear optical crystal 10 housed inside the housing 20. Furthermore, the arm mechanism 22 having the first end mounted rotatably is rotated by an actuator such as a non-depicted motor. From the second end side of the arm mechanism 22, the terahertz wave TH generated by the optical system 4 is emitted to the inner peripheral surface of the inspection target TG, and the reflection wave RW from the inner peripheral surface is received.

Furthermore, the arm mechanism 22 includes a distance measurement part 28 for measuring the distance between the arm mechanism 22 and the inner peripheral surface of the inspection target TG. The distance measurement part 28 is a laser distance measurement device capable of measuring distances using a laser light LL, for instance. The distance measurement part 28 emits a laser light LL to the inner peripheral surface of the inspection target TG substantially parallel to the terahertz wave TH from the substantially same position as the terahertz wave TH, and detects a laser reflection light LR from the inner peripheral surface of the inspection target TG at the substantially same position as the reflection wave RW, thereby being capable of measuring the distance between the arm mechanism 22 and the inner peripheral surface of the inspection target TG. The distance measurement part 28 is fixed to the arm mechanism 22, and is rotatable about the rotational center C1 along with the arm mechanism 22. Furthermore, it is possible to convert the distance measured by the distance measurement part 28 into the distance from the rotational center C1 to the inner peripheral surface of the inspection target TG, by taking into account the distance from the rotational center Cl to the emission position of the laser light LL or to the detection position of the laser reflection light LR.

Furthermore, the inspection device 1 includes a control device 30 for controlling each of the above components. The control device 30 is a control unit for controlling the inspection device 1, and includes, for instance, a central processing unit (CPU), a random access memory (RAM), a read only memory (ROM), and a storage medium or the like that is readable with a computer. Further, the series of processes for realizing the various functions is stored in a storage medium or the like in the form of program, for instance. As the CPU reads the program out to the RAM or the like and executes processing and calculation of information, various functions are realized. The program may be installed in advance in the ROM or another storage medium, provided in a state stored in a storage medium that is readable by a computer, or may be distributed via wired communication or wireless communication. A storage medium that is readable by a computer includes a magnetic disc, a magneto-optic disc, a CD-ROM, a DVD-ROM, a semiconductor memory, and the like.

While the control device 30 is configured as a separate body from the body 6 of the inspection device 1 and capable of communicating with one another in FIG. 1, at least a part of the control device 30 may be configured integrally with the body 6. Furthermore, the control device 30 is connected to the body 6 via a wired or wireless communication means so that various types of data are transmittable.

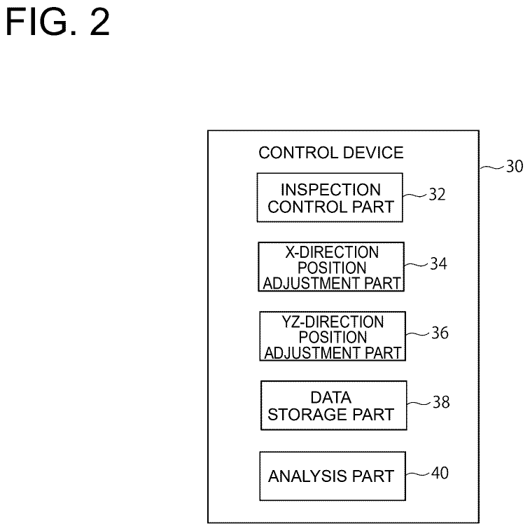

FIG. 2 is a block configuration diagram of the control device 30 in FIG. 1. The control device 30 includes an inspection control part 32, an X-direction position adjustment part 34, a YZ-direction position adjustment part 36, a data storage part 38 and an analysis part 40.

The inspection control part 32 is a component for controlling the inspection motion by the inspection device 1. The inspection motion includes emitting the terahertz wave TH to the inner peripheral surface of the inspection target TG while rotating the arm mechanism 22 with respect to the housing 20, and detecting the reflection wave RW from the inner peripheral surface of the inspection target TG. Furthermore, the inspection motion may include, as a part of such inspection, a distance measurement motion by the distance measurement part 28 as needed. That is, when the inner peripheral surface of the inspection target TG is inspected while rotating the arm mechanism 22, the distance measurement by the distance measurement part 28 may be performed simultaneously. Furthermore, in the inspection motion, only the distance measurement by the distance measurement part 28 may be performed (the inspection motion of this case will be referred to as “distance measurement motion” as needed). The data obtained by the above inspection motion (inspection data) is associated with the circumferential-directional position on the inner circumferential surface, and stored in the data storage part 38 described below along with the circumferential-directional position as needed.

In a case where the inspection data is obtained as analog data by the inspection motion, the inspection control part 32 may include an A/D converter for converting the analog data to calculatable digital data.

The X-direction position adjustment part 34 is a component for adjusting the position of the inspection device 1 along the axial direction X (axial-directional position). The inspection motion is performed repetitively while changing the X-direction position, and thereby it is possible to inspect a wide range of the inner peripheral surface of the inspection target TG. The X-direction position adjustment part 34 performs position adjustment of the inspection device 1 along the axial direction X in conjunction with the inspection motion (hereinafter, also referred to as “X-direction position adjustment motion” as needed).

In the present embodiment, in a state where the inspection target TG is fixed, the inspection device 1 is moved so as to change the X-direction position of the inspection device 1 inserted into the internal space 2 of the inspection target TG, and thereby the X-direction position adjustment motion is performed. In another embodiment, the X-direction position adjustment motion may be performed by changing the X-direction position of the inspection target TG in a state where the inspection device 1 is fixed. Alternatively, the X-direction position adjustment motion may be performed by changing the X-direction position of both of the inspection device 1 and the inspection target TG relatively.

The YZ-direction position adjustment part 36 is a component for adjusting the position of the inspection device 1 on the YZ plane (plane perpendicular to the axial direction X) (hereinafter, also referred to as “YZ-direction position adjustment motion” as needed). The adjustment amount by the YZ-direction position adjustment part 36 is controlled on the basis of the measurement result by the distance measurement part 28. For instance, the adjustment amount is determined so that the rotational center C1 is positioned on the center axis C2 of the inspection target TG on the basis of the distance data obtained by the distance measurement part 28 while rotating the arm mechanism 22, in a state where the axial-directional position of the inspection device 1 is fixed. More specifically, the adjustment amount is determined by calculating the average value of the distance data in the circumferential direction so that the deviation of each distance data from the average value becomes minimum. Accordingly, the position of the inspection device 1 on the YZ plane is adjusted preferably by the YZ-direction position adjustment motion so that the rotational center C1 of the inspection device 1 matches the center axis C2. As a result, emission of the terahertz wave TH and detection of the reflection wave RW are performed on the center axis C2 of the inspection target TG, and thereby it is possible to accurately perform inspection using the terahertz wave TH being an electromagnetic wave with a high directionality and an excellent straightness.

The data storage part 38 is a component for storing various types of data required for control calculation of the control device 30. The data stored in the data storage part 38 includes inspection data obtained by inspection motion (including the distance data obtained by the distance measurement motion).

The analysis part 40 is a component for analyzing various types of data stored in the data storage part 38 to obtain a detection result.

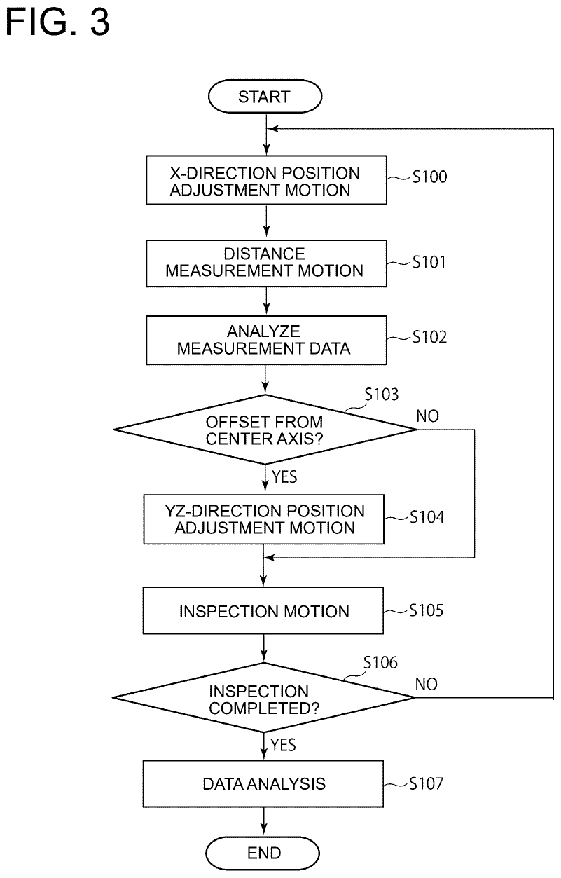

Next, an inspection method to be performed by the inspection device 1 having the above configuration will be described. FIG. 3 is a flowchart of an inspection method according to an embodiment.

Firstly, the control device 30 performs the X-direction position adjustment motion with the X-direction position adjustment part 34 to adjust the axial-directional position of the inspection device 1 (step S100). For instance, in a case where inspection is to be performed at a plurality of axial-directional positions according to an inspection plan, the X-direction position is adjusted so that the inspection device 1 becomes the first axial-directional position.

Next, the distance measurement motion is performed at the X-direction position adjusted in step S100 (step S101). In the distance measurement motion, distance measurement is performed while rotating the distance measurement part 28 along with the arm mechanism 22 in a state where the X-direction position is fixed. The distance data measured by the distance measurement part 28 is stored readably in the data storage part 38 as needed.

Next, the YZ-direction position adjustment part 36 analyzes the distance data obtained in step S101 (step S102), and determines whether the rotational center C1 is offset from the center axis C2 of the inspection target TG on the YZ plane (step S103). In step S102, the distance data obtained in step S101 is analyzed, and thereby, for instance, the average value of the distance data in the circumferential direction is calculated, and the deviation of each distance data from the average value is calculated. In step S103, it is determined whether the rotational center C1 is offset from the center axis C2 of the inspection target TG on the basis of whether the deviation is greater than a threshold value that is set in advance.

If it is determined that the rotational center C1 is offset from the center axis C2 of the inspection target TG (step S103: YES), the YZ-direction position adjustment motion is performed so as to position the rotational center C1 at the center axis C2 of the inspection target S2 (step S104). The adjustment amount for the YZ-direction position adjustment mechanism in step S104 is determined so that the above described deviation becomes the threshold value or less, for instance.

If the rotational center C1 is not offset from the center axis C2 of the inspection target TG (step S103: NO), the YZ-direction position adjustment motion in step S104 is unnecessary.

Next, the inspection control part 32 performs the inspection motion (step S105). In step S105, the arm mechanism 22 is rotated at the axial-directional position adjusted in step S100 (the same axial-directional position as the axial-directional position when the distance measurement motion is performed in step S101), and thereby inspection (emission of the terahertz wave TH and detection of the reflection wave RW) is performed on the inner peripheral surface of the inspection target TG along the circumferential direction. The inspection data obtained by the inspection is stored readably in the data storage part 38 as needed.

Next, the control device 30 determines whether the inspection content in the inspection plan is completed (step S106). For instance, in a case where inspection is to be performed at a plurality of axial-directional positions, it is determined whether the inspection content is completed on the basis of whether the axial-directional position moved in step S100 is the last inspection position. If there is a subsequent inspection position (step S106: NO), it is determined that the inspection is not completed and the process returns to step S100, and thereby the same process is repeated at the axial-directional position being the subsequent inspection position.

If the inspection content in the inspection plan is all completed (step S106: YES), the analysis part 40 analyzes the data stored in the data storage part 38 and obtains a detection result (step S107).

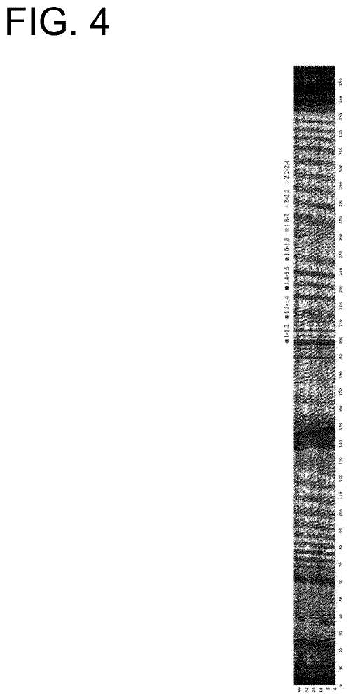

FIG. 4 is an example of an inspection result obtained in step S107 of FIG. 3. In FIG. 4, y-axis represents the axial-directional position (X-direction position) and x-axis represents the phase angle (zero to 360 angle degrees) corresponding to the circumferential-directional position. The surface state of the inner peripheral surface of the inspection target TG is imaged as a distribution of the signal strength of the reflection wave RW. Particularly in FIG. 4, if the surface state of the inner peripheral surface is normal, the signal strength of the reflection wave RW is substantially constant, but the signal strength decreases locally where there is an abnormality such as water and corrosion. Thus, it is possible to differentiate a normal state and an abnormal state visually.

Particularly in the present embodiment, in the YZ-direction position adjustment motion, the YZ-direction position adjustment mechanism is adjusted so that the rotational center C1 is positioned on the center axis C2 of the inspection target TG on the basis of the distance data before performing the inspection motion. Therefore, in a case where the terahertz wave TH having a high directionality and an excellent straightness is used, if the surface state of the inner peripheral surface is normal, the signal strength of the reflection wave RW becomes substantially constant, and thus it is possible to show a region with an abnormality in an identifiable manner, and obtain a high inspection accuracy.

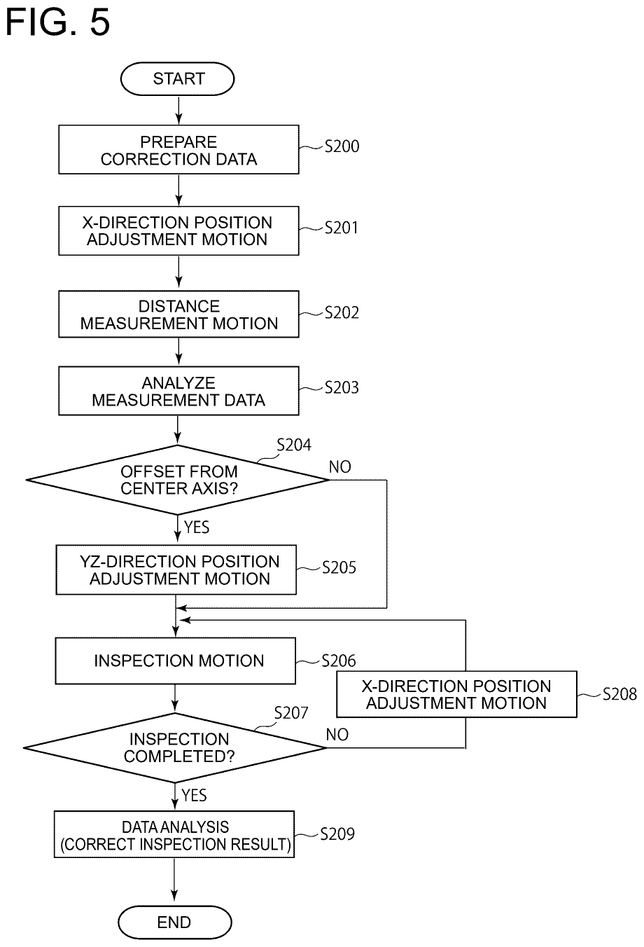

Next, with reference to FIG. 5, an inspection method according to another embodiment will be described. FIG. 5 is a flowchart of an inspection method according to another embodiment.

In the present embodiment, as a preparation, correction data for correcting the inspection data is prepared (step S200). The correction data is prepared as correlation data indicating the relationship between the propagation distance and the signal strength of the reflection wave RW detected by the detection part 18.

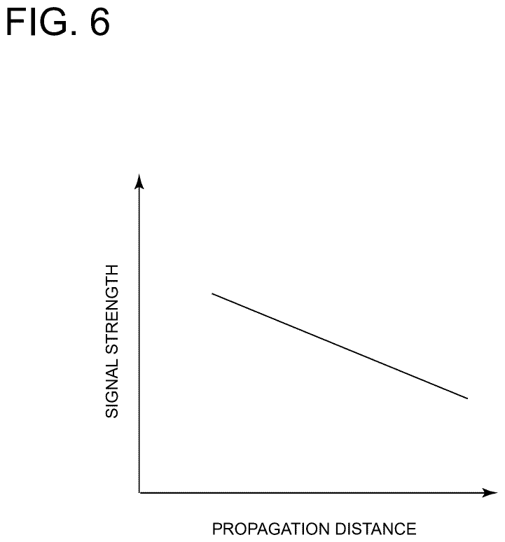

FIG. 6 is an example of correction data prepared in step S200 of FIG. 5. In this example, the correction data is prepared as data indicating the relationship between the propagation distance and the signal strength of the reflection wave RW, and indicates that there is a trend that the signal strength decreases as the propagation distance increases. Such correction data is prepared by an experimental, theoretical, or simulational method under the same condition or a similar condition as the inspection device 1.

Next, the X-direction position adjustment part 34 performs the X-direction position adjustment motion to adjust the axial-directional position of the inspection device 1, similarly to the above described step S100 (stepS201). For instance, in a case where inspection is to be performed at a plurality of directional positions in an inspection plan, the X-direction position is adjusted so that the inspection device 1 becomes the first axial-directional position.

Next, the distance measurement motion is performed at the X-direction position adjusted in step S201, as similarly to the above described step S01 (step S202). In the distance measurement motion, distance measurement is performed while rotating the distance measurement part 28 along with the arm mechanism 22 in a state where the X-direction position is fixed. The distance data measured by the distance measurement part 28 is stored readably in the data storage part 38 as needed.

Next, similarly to the above described steps S102 and S103, the YZ-direction position adjustment part 36 analyzes the distance data obtained in step S202 (step S203), and determines whether the rotational center C1 is offset from the center axis C2 of the inspection target TG on the YZ plane (step S204). In step S203, the distance data obtained in step S202 is analyzed, and thereby the average value of the distance data in the circumferential direction is calculated, and the deviation of each distance data from the average value is calculated. In step S204, it is determined whether the rotational center C1 is offset from the center axis C2 of the inspection target TG on the basis of whether the deviation is greater than a threshold value that is set in advance.

If it is determined that the rotational center C1 is offset from the center axis C2 of the inspection target TG (step S204: YES), the YZ-direction position adjustment motion is performed so as to position the rotational center C1 on the center axis C2 of the inspection target S2 (step S205). The adjustment amount for the YZ-direction position adjustment mechanism in step S205 is determined so that the above described deviation becomes a threshold value or less, for instance.

If the rotational center C1 is not offset from the center axis C2 of the inspection target TG (step S204: NO), the YZ-direction position adjustment motion in step S205 is unnecessary.

Next, similarly to the above described step S105, the inspection control part 32 performs the inspection motion (step S206). In step S206, the arm mechanism 22 is rotated at the axial-directional position adjusted in step S101 (the same axial-directional position as the axial-directional position when the distance measurement motion is performed in step S202), and thereby inspection (emission of the terahertz wave TH and detection of the reflection wave RW) is performed on the inner peripheral surface of the inspection target TG along the circumferential direction. The inspection data obtained by the inspection is stored readably in the data storage part 38 as needed.

Next, similarly to the above described step S106, the control device 30 determines whether the inspection content in the inspection plan is completed (step S207). For instance, in a case where inspection is performed at a plurality of axial-directional positions, it is determined whether the inspection content is completed on the basis of whether the axial-directional position moved in step S201 is the last inspection position. If there is a subsequent inspection position (step S207: NO), it is determined that the inspection is not completed, the X-direction position adjustment motion is performed again (step S208), and the process is returned to step S206, and thereby the same inspection motion is repetitively performed at the axial-directional position being the subsequent inspection position. That is, in the present embodiment, the YZ-direction position adjustment motion is performed only at the first axial-directional position, and not performed at the subsequent axial-directional positions. Thus, the number of executions of the YZ-direction position adjustment motion is small (only once), and it is possible to considerably shorten the time required for the entire inspection.

If the inspection motion is completed at each axial-directional position (step S207: YES), the analysis part 40 analyzes the data stored in the data storage part 38 and obtain an inspection result (step S209). The data analysis in step S209 includes a correction process of the inspection data using the correction data prepared in step S200. In the correction process, the distance from the rotational center C1 to the inner peripheral surface of the inspection target TG is determined on the basis of the distance data as well as the inspection data, and thus the signal strength to be obtained in a case where the distance is the propagation distance is obtained on the basis of the correction data prepared in step S200 (see FIG. 6). In the correction process, by correcting the signal strength of the reflection wave RW obtained as an actual measurement value on the basis of the signal strength obtained as described above, it is possible to suppress deterioration of the inspection accuracy effectively even if the rotational center C1 is offset from the center axis C2 of the inspection target TG.

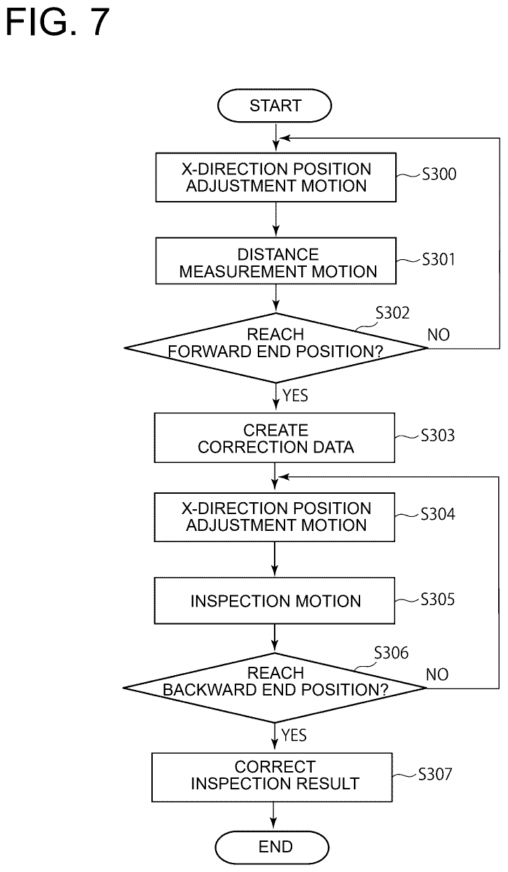

Next, with reference to FIG. 7, yet another embodiment will be described. FIG. 7 is a flowchart of an inspection method according to another embodiment. In each of the above described embodiments, inspection is performed while moving in a single direction along the axial direction of the inspection target TG. In the embodiment described below, inspection is performed while moving in at least two directions (that is, the forward direction and the backward direction) along the axial direction of the inspection target TG.

Firstly, in the forward direction, the control device 30 performs the X-direction position adjustment motion to adjust the axial-directional position of the inspection device 1 (step S300), and performs the distance measurement motion (step S301). That is, in the forward direction, the inspection motion (emission of the terahertz wave TH and detection of the reflection wave RW) is not performed, and only the distance to the inner peripheral surface of the inspection target TG is measured along the circumferential direction (measurement of the distance may be performed along the circumferential direction while the axial-directional position is fixed, similarly to each of the above described embodiments, or along a spiral pattern in combination with adjustment of the axial-directional position). Steps S300 and S301 are performed repetitively until the axial-directional position reaches the forward direction end position in the inspection plan (step S302). Accordingly, in the forward direction, the distance data is obtained over a range in the inspection plan. The distance data is associated with the axial-directional position, and stored in the data storage part 38 as needed.

Subsequently, the correction data is created using the distance data obtained in the forward direction (step S303). The correction data includes the distance data of each axial-directional position (distance to the inner peripheral surface of the inspection target TG), and is used to correct the inspection data obtained in the backward direction. The correction data created in step S303 may be stored in the data storage part 38 as needed.

Subsequently, in the backward direction, the control device 30 performs the X-direction position adjustment motion to adjust the axial-directional position of the inspection device 1 (step S304), and performs the inspection motion (step S305). Steps S304 and S305 are performed repetitively until the axial-directional position reaches the backward direction end position (step S306). Accordingly, in the backward direction, the inspection data is obtained over the range in the inspection plan. The inspection data is associated with the axial-directional position, and stored in the data storage part 38 as needed.

In steps S300 to S302 in the forward direction, the distance measurement may be performed on the inner peripheral surface of the inspection target TG in a spiral pattern, for instance, as a result of the X-direction position adjustment motion and the distance measurement motion being performed simultaneously. In this case, also in steps S304 to S306 in the backward direction, the inspection motion may be performed on the inner peripheral surface of the inspection target TG in a spiral pattern, for instance, as a result of the X-direction position adjustment motion and the inspection motion being performed simultaneously.

Next, the inspection data obtained by performing steps S304 to S306 repetitively is corrected using the correction data created in step S303 (step S307). In the present embodiment, while the YZ position adjustment motion is not performed in steps S304 to S306 where the inspection data is obtained in the backward direction, a correction process is performed using the correction data created on the basis of the distance data obtained in the forward direction, and thereby it is possible to reduce the influence of the misalignment of the rotational center C1 from the center axis C2 of the inspection target TG. As a result, compared to the above described embodiment where the YZ position adjustment motion is performed every time the inspection motion is performed, it is possible to improve the inspection accuracy preferably while reducing the time required for the inspection.

It is possible to replace a constituent element of the above embodiment with a known constituent element without departing from the scope of the present disclosure, and the above embodiments may be combined appropriately.

The contents described in the above respective embodiments can be understood as follows, for instance.
(1) An inspection device according to an aspect is an inspection device for inspecting an inner peripheral surface of an inspection target having a cylindrical shape and includes: an inspection part for emitting a terahertz wave to the inner peripheral surface and detecting a reflection wave of the terahertz wave; a distance measurement part for measuring a distance between the inspection part and the inner peripheral surface; a rotation part for rotating the inspection part and the distance measurement part along a circumferential direction of the inspection target; a position adjustment mechanism for adjusting a position of the inspection part on a plane which intersects with an axial direction of the inspection target; and an axial-direction position adjustment part for adjusting an axial-direction position of the inspection part relative to the inspection target. The position adjustment mechanism is configured to be controlled such that a rotational center of the rotation part is positioned on a center axis of the inspection target on the basis of a measurement result of the distance measurement part.

According to the above aspect (1), the inspection part emits the terahertz wave to the inner peripheral surface of the inspection target while being rotated along the circumferential direction, and detects the reflection wave from the inner peripheral surface, thereby performing inspection. The position of the inspection device on the plane intersecting with the axial direction is adjusted so that the rotational center is positioned at the center axis of the inspection target on the basis of the measurement result of the distance measured by the distance measurement part rotated along with the inspection part. Accordingly, it is possible to accurately perform inspection using the terahertz wave being an electromagnetic wave having a high directionality and an excellent straightness.
(2) In another aspect, in the above aspect (1), an adjustment amount of the position adjustment mechanism is determined on the basis of the distance measured when the rotation part rotates the distance measurement part in the circumferential direction in a state where the axial-direction position is fixed.

According to the above aspect (2), the rotational center of the inspection part and the distance measurement part is adjusted to be positioned preferably on the center axis of the inspection target, and thereby it is possible to effectively improve the accuracy of inspection using the terahertz wave TH.
(3) In another aspect, in the above aspect (2), the adjustment amount is determined so that a deviation of the distance becomes minimum with regard to an average value of the distance measured when the rotation part rotates the distance measurement part in the circumferential direction in a state where the axial-direction position is fixed.

According to the above aspect (3), the adjustment amount of the position adjustment mechanism is determined so that a deviation of the distance becomes minimum with regard to an average value of the distance measured while the rotation part rotates the distance measurement part in the circumferential direction in a state where the axial-direction position is fixed. By controlling the position adjustment mechanism on the basis of the adjustment amount obtained as described above, it is possible to position the inspection part on the center axis preferably.
(4) In another aspect, in any one of the above aspects (1) to (3), the position adjustment mechanism is controlled before the inspection part inspects the inner peripheral surface each time the axial-directional position changes.

According to the above aspect (4), the position adjustment mechanism adjusts the rotational axis to be positioned on the center axis each time the axial-directional position of the inspection part changes. By performing inspection after such position adjustment, it is possible to obtain an excellent inspection accuracy.
(5) In another aspect, in any one of the above aspects (1) to (3), the inspection part is configured to perform inspection at a plurality of axial-direction positions after the position adjustment mechanism is controlled.

According to the above aspect (5), inspection is performed at a plurality of axial-direction positions after the position adjustment mechanism adjusts the rotational axis to be positioned on the center axis. Accordingly, it is possible to perform inspection at a plurality of axial-directional positions efficiently while reducing the number of position adjustment.
(6) In another aspect, in the above aspect (5), a relationship between a signal strength of the reflection wave detected by the inspection part and the distance measured by the distance measurement part is prepared in advance as correction data, and the signal strength of the reflection wave detected by the inspection part is corrected on the basis of the distance measured by the distance measurement part using the correction data.

According to the above aspect (6), a relationship between a signal strength of the reflection wave detected by the inspection part and the distance measured by the distance measurement part is prepared in advance as correction data. By referring to the correction data to correct the signal strength of the reflection wave detected corresponding to the distance measured by the distance measurement, it is possible to improve the inspection accuracy while reducing the number of position adjustment by the position adjustment mechanism.
(7) In another aspect, in any one of the above aspects (1) to (6), a signal strength of the reflection wave detected by the inspection part is corrected using correction data associating the signal strength of the reflection wave detected by the inspection part and the distance measured by the distance measurement part while moving along the axial direction.

According to the above aspect (7), a relationship between the signal strength of the reflection wave detected by the inspection part and the distance measured by the distance measurement part while moving along the axial direction is prepared in advance as correction data. The correction data is used upon the subsequent inspection to correct the signal strength of the reflection wave detected by the inspection part, and thereby it is possible to effectively enhance the inspection accuracy.
(8) In another aspect, in any one of the above aspects (1) to (7), the distance measurement part is a laser measurement instrument capable of measuring the distance using laser light.

According to the above aspect (8), by using a laser measurement instrument as the distance measurement part, it is possible to measure the distance between the inspection part and the inspection target preferably.
(9) In another aspect, in any one of the above aspects (1) to (8), the terahertz wave is generated by optical wavelength conversion of pulse excitation light having a duration between ten picoseconds and ten nanoseconds using a non-linear optical crystal.

According to the above aspect (9), the inspection part is capable of emitting a strong (having a high output) terahertz wave compared to an oscillator constituted of a semiconductor element such as RTD and RCA, by optical wavelength conversion of pulse excitation light having a duration between ten picoseconds and ten nanoseconds using a non-linear optical crystal. By using such a strong terahertz wave, it is possible to perform inspection accurately on the inspection target having a small SN ratio (signal-noise ratio) and positioned at a lower layer of a low-permeability material.

### Reference Signs List

1 Inspection device
2 Internal space
4 Optical system
8 Light source
10 Nonlinear optical crystal
12 Half mirror
14 Mirror
16 Condenser lens
18 Detector
20 Housing
22 Arm mechanism
24 Multiaxial arm
26 Traveling wheel
28 Distance measurement part
30 Control device
32 Inspection control part
34 X-direction position adjustment part
36 YZ-direction position adjustment part
38 Data storage part
40 Analysis part
TG Inspection target
RM Resin material
LB Pulse excitation light
TH Terahertz wave
RW Reflection wave
LL Laser light
LR Laser reflection light
C1 Rotational center
C2 Center axis

1. An inspection device for inspecting an inner peripheral surface of an inspection target having a cylindrical shape, the inspection device comprising:
an inspection part for emitting a terahertz wave to the inner peripheral surface and detecting a reflection wave of the terahertz wave;
a distance measurement part for measuring a distance between the inspection part and the inner peripheral surface;
a rotation part for rotating the inspection part and the distance measurement part along a circumferential direction of the inspection target;
a position adjustment mechanism for adjusting a position of the inspection part on a plane which intersects with an axial direction of the inspection target; and
an axial-direction position adjustment part for adjusting an axial-direction position of the inspection part relative to the inspection target,
wherein the position adjustment mechanism is configured to be controlled such that a rotational center of the rotation part is positioned on a center axis of the inspection target on the basis of a measurement result of the distance measurement part.

2. The inspection device according to claim 1,
wherein an adjustment amount of the position adjustment mechanism is determined on the basis of the distance measured when the rotation part rotates the distance measurement part in the circumferential direction in a state where the axial-direction position is fixed.

3. The inspection device according to claim 2,
wherein the adjustment amount is determined so that a deviation of the distance becomes minimum with regard to an average value of the distance measured when the rotation part rotates the distance measurement part in the circumferential direction in a state where the axial-direction position is fixed.

4. The inspection device according to claim 1,
wherein the position adjustment mechanism is controlled before the inspection part inspects the inner peripheral surface each time the axial-directional position changes.

5. The inspection device according to claim 1,
wherein the inspection part is configured to perform inspection at a plurality of axial-direction positions after the position adjustment mechanism is controlled.

6. The inspection device according to claim 5,
wherein a relationship between a signal strength of the reflection wave detected by the inspection part and the distance measured by the distance measurement part is prepared in advance as correction data, and the signal strength of the reflection wave detected by the inspection part is corrected on the basis of the distance measured by the distance measurement part using the correction data.

7. The inspection device according to claim 1,
wherein a signal strength of the reflection wave detected by the inspection part is corrected using correction data associating the signal strength of the reflection wave detected by the inspection part and the distance measured by the distance measurement part while moving along the axial direction.

8. The inspection device according to claim 1,
wherein the distance measurement part is a laser measurement instrument capable of measuring the distance using laser light.

9. The inspection device according to claim 1,
wherein the terahertz wave is generated by optical wavelength conversion of pulse excitation light having a duration between ten picoseconds and ten nanoseconds using a non-linear optical crystal.
